(19) United States
(12) Patent Application Publication
(10) Pub. No.: US 2026/0031601 A1
(43) Pub. Date: Jan. 29, 2026

(54) WIRE STRIPPER

(71) Applicant: NUSHARP INC., TAICHUNG CITY (TW)

(72) Inventors: Chong-Jiang LIN, TAICHUNG CITY (TW); Tsung-Hao KUO, TAICHUNG CITY (TW)

(21) Appl. No.: 19/176,086

(22) Filed: Apr. 10, 2025

(30) Foreign Application Priority Data
Jul. 26, 2024 (TW) 113127768

(51) Int. Cl. H02G 1/12

(52) U.S. Cl. CPC H02G 1/1217

(57) ABSTRACT

Provided is a wire stripper, including: a body having wire duct, the wire duct having a lower duct surface, an upper duct surface facing the lower duct surface, a lateral duct surface connecting the upper duct surface and the lower duct surface, a stop portion disposed on the lower duct surface and spaced apart from the lateral duct surface by a distance, and a fulcrum portion disposed on the upper duct surface and facing the lower duct surface; and a blade fixedly disposed on the body and having a cutting edge portion protruding from the lower duct surface and thus located inside the wire duct. Therefore, the wire stripper not only enhances wire stripping efficiency but also ensures the precision and safety of the operation.

### BACKGROUND

### FIELD OF THE INVENTION

The present disclosure relates to wire strippers, and more particularly to a wire stripper for removing outer insulating layers of wires, cables, and the like.

### DESCRIPTION OF RELATED ART

A conventional wire stripper is a tool used to remove insulating sheaths of wires and cables in order for connection-related or other electrical tasks to be carried out. The wire stripper is effective in removing the insulating sheaths precisely without damaging the wires and cables.

The conventional wire stripper typically has a ring-shaped stripping structure, such as a pair of pinchers in wide use, to handle wires with insulating sheaths of uniform thickness. This design gives little consideration to the need for making a longitudinal cut to carry out a wire stripping process. In practice, in case of very long wires that have to undergo wire stripping, workers will need craft knives or scissors for manually making a longitudinal cut on the insulating sheaths to expose the conducting wires and then transversely severing the insulating sheaths. However, the aforesaid longitudinal wire stripping technique has drawbacks as follows: the conducting wires are likely to be damaged under an uneven applied force, and the stability of the longitudinal cutting process is insufficient to ensure worker safety.

### SUMMARY

It is an objective of the disclosure to provide a wire stripper that overcomes the aforesaid drawbacks of the prior art.

To achieve the above and other objectives, the disclosure is a wire stripper, comprising: a body having a wire duct, the wire duct having a lower duct surface, an upper duct surface facing the lower duct surface, a lateral duct surface connecting the upper duct surface and the lower duct surface, a stop portion disposed on the lower duct surface and spaced apart from the lateral duct surface by a distance, and a fulcrum portion disposed on the upper duct surface and facing the lower duct surface; and a blade fixedly disposed on the body and having a cutting edge portion protruding from the lower duct surface and thus located inside the wire duct.

The advantages of the disclosure are described below. The wire stripper of the disclosure has a fulcrum portion for abutting against a wire (or cable) and a blade. In practice, the wire is transversely place inside the wire duct of the body such that the upper end of one side of the wire abuts against the fulcrum portion. Then, the body is pulled upward such that the fulcrum portion presses against one side of the wire and press down the wire according to the lever principle. Thus, the cutting edge portion of the blade pierces the lower end of the other side of the wire, and then the body or the wire is moved in the lengthwise direction of the wire in order for the wire to be cut longitudinally. According to the disclosure, during a wire stripping process, the wire has one end abutting against the fulcrum portion and the other end pierced by the cutting edge portion of a fixed height. Thus, the cut made to the wire with the blade has a fixed depth, and thus the conducting wire inside the wire is unlikely to get damaged under an uneven applied force. The longitudinal cutting process performed on the wire is confined to the wire duct of the body to greatly enhance operation safety and reduce hazards that might otherwise occur in the course of the operation. The disclosure not only enhances wire stripping efficiency but also ensures the precision and safety of the operation.

Preferably, the fulcrum portion of the body is a roller rotatably disposed on the body and having a roller surface, and a portion of the roller surface protrudes from the upper duct surface and thus is located inside the wire duct, optimizing smoothness of displacement of the wire stripper relative to the wire.

Preferably, the height of the cutting edge portion of the blade is equal to or less than that of the stop portion of the body.

Preferably, the cutting edge portion of the blade and the fulcrum portion of the body are not aligned with each other.

Preferably, the body further has a receiving portion and a gripping portion connected to the receiving portion, and the wire duct is disposed on the receiving portion.

Preferably, the wire stripper further comprises a security component operably disposed on the body, configured to switch between a first position and a second position, and having an enclosing portion for enclosing the cutting edge portion, allowing the enclosing portion not to be protruded and exposed inside the wire duct when the security component is at the first position, and allowing the enclosing portion to protrude from the upper duct surface and enclose the cutting edge portion when the security component is at the second position.

Preferably, the security component further has a push portion exposed from the body.

Preferably, the body further has an operating groove adjoining the wire duct and having a groove bottom surface, with the groove bottom surface having a first positioning recess and a second positioning recess closer to the wire duct than the first positioning recess, allowing the security component to be operably disposed in the operating groove and have a positioning bump configured to be positioned inside the first positioning recess or the second positioning recess.

### BRIEF DESCRIPTION OF THE DRAWINGS

FIG. 1 is a perspective view of a wire stripper in the first embodiment of the disclosure;

FIG. 2A is an exploded view of the wire stripper in the first embodiment of the disclosure;

FIG. 2B is an exploded view of the wire stripper, shown from another angle, according to the first embodiment of the disclosure;

FIG. 3 is a front view of the wire stripper in the first embodiment of the disclosure;

FIG. 4 is a cross-sectional view of the wire stripper taken along line 4-4 of FIG. 3;

FIG. 5 is a cross-sectional view based on FIG. 4 according to the first embodiment of the disclosure, showing a wire with one end abutting against a fulcrum portion and the other end pierced by a cutting edge portion;

FIG. 6 is a cross-sectional view based on FIG. 4 according to the first embodiment of the disclosure, showing a security component at a second position; and

FIG. 7 is a perspective view of a wire stripper in the second embodiment of the disclosure.

### DETAILED DESCRIPTION

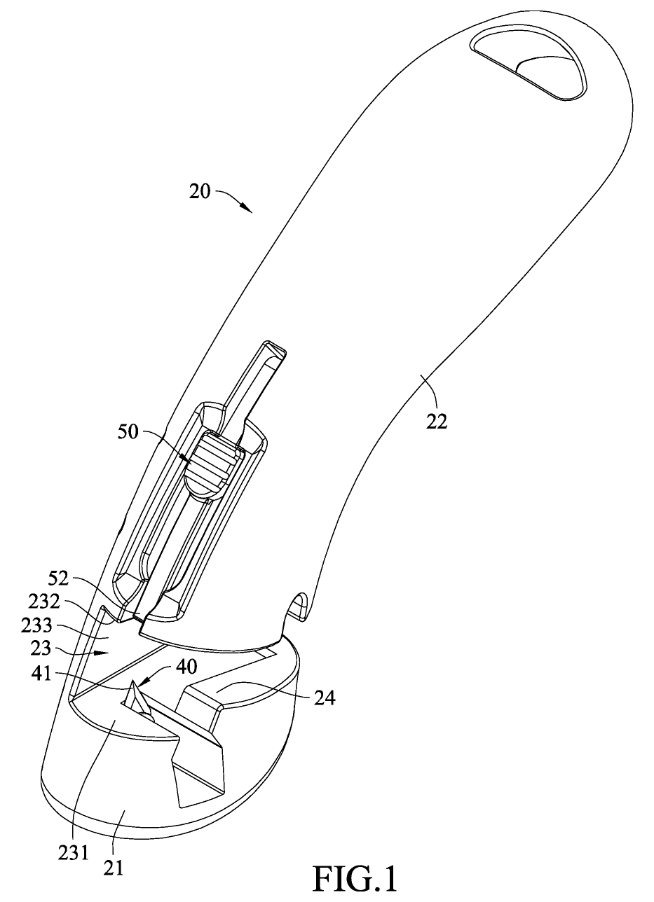

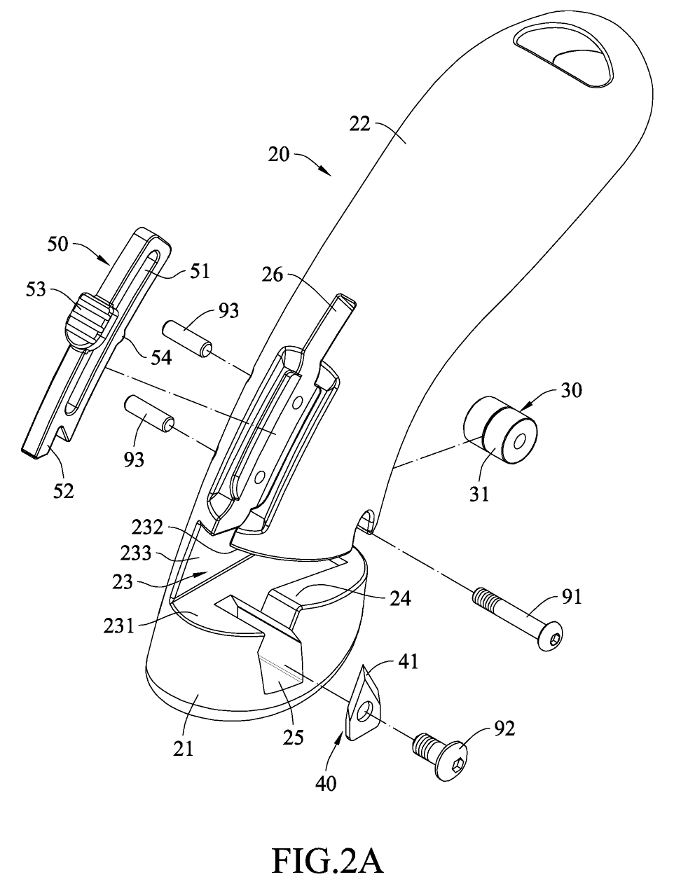

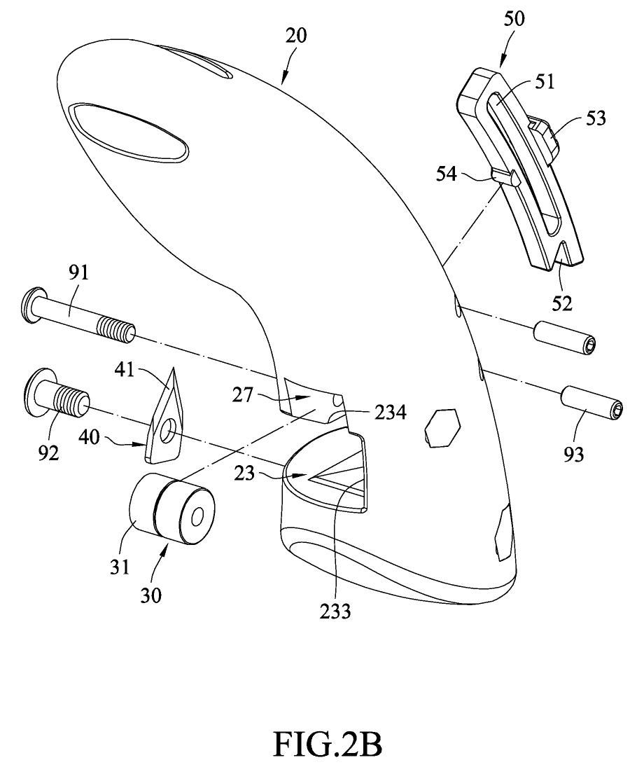

Referring to FIG. 1 through FIG. 4, the first embodiment of the disclosure provides a wire stripper configured to remove an insulating sheath 11 of a wire 10 (or cable). The wire stripper essentially comprises a body 20, a roller 30, a blade 40, and a security component 50.

The body 20 has a receiving portion 21, a gripping portion 22 connected to the receiving portion 21 and configured to be gripped by the human hand, a wire duct 23 disposed on the receiving portion 21, extending transversely and denting, a stop portion 24 disposed at the wire duct 23, a blade slot 25 disposed in the receiving portion 21 and being in communication with the wire duct 23, an operating groove 26 disposed in the gripping portion 22 and being in communication with the wire duct 23, and a roller groove 27 disposed in the gripping portion 22 and being in communication with the wire duct 23. The wire duct 23 receives the wire 10 transversely and has a lower duct surface 231, an upper duct surface 232 facing the lower duct surface 231, a lateral duct surface 233 connecting the upper duct surface 232 and the lower duct surface 231 and preventing the wire 10 from protruding laterally, and a fulcrum portion 234 disposed on the upper duct surface 232 and facing the lower duct surface 231. In this embodiment, the fulcrum portion 234 is provided in the form of the roller 30. The roller 30 is rotatably disposed on the roller groove 27 of the body 20 through a wheel shaft 91. The roller 30 has a roller surface 31. A portion of the roller surface 31 protrudes from the upper duct surface 232 and thus is located inside the wire duct 23. The roller surface 31 is in contact with the surface of the wire 10, optimizing the smoothness of the displacement of the wire stripper relative to the wire 10. The stop portion 24 is disposed on the lower duct surface 231 and spaced apart from the lateral duct surface 233 by a distance approximately equal to the wire diameter of the wire 10. The stop portion 24 and the lateral duct surface 233 jointly restrict the lateral displacement of the wire 10 such that the wire 10 securely spans across the wire duct 23. The operating groove 26 has a groove bottom surface 261. The groove bottom surface 261 has a first positioning recess 262 and a second positioning recess 263 closer to the wire duct 23 than the first positioning recess 262.

The blade 40 is fixedly disposed on the blade slot 25 of the body 20, using a screw 92. The blade 40 further has a cutting edge portion 41 protruding from the body 20 and thus located inside the wire duct 23. In this embodiment, the cutting edge portion 41 of the blade 40 and the fulcrum portion 234 of the body 20 are not aligned with each other.

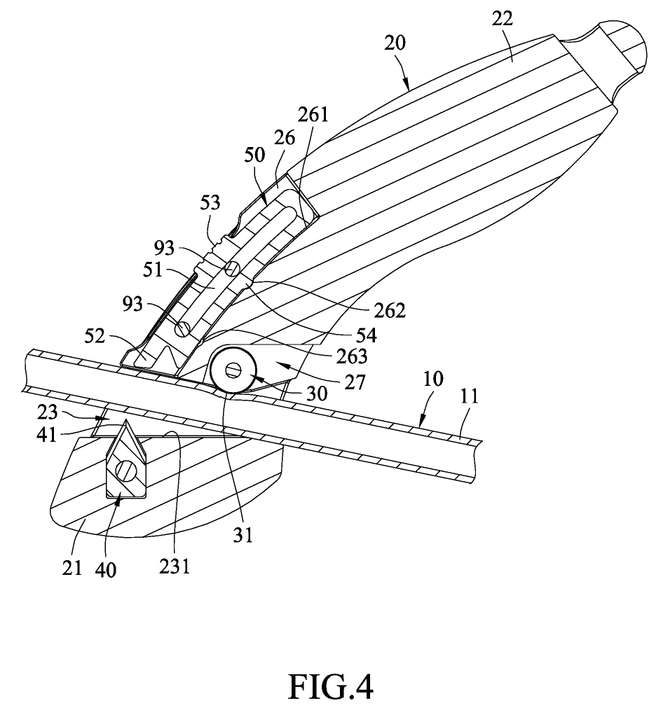

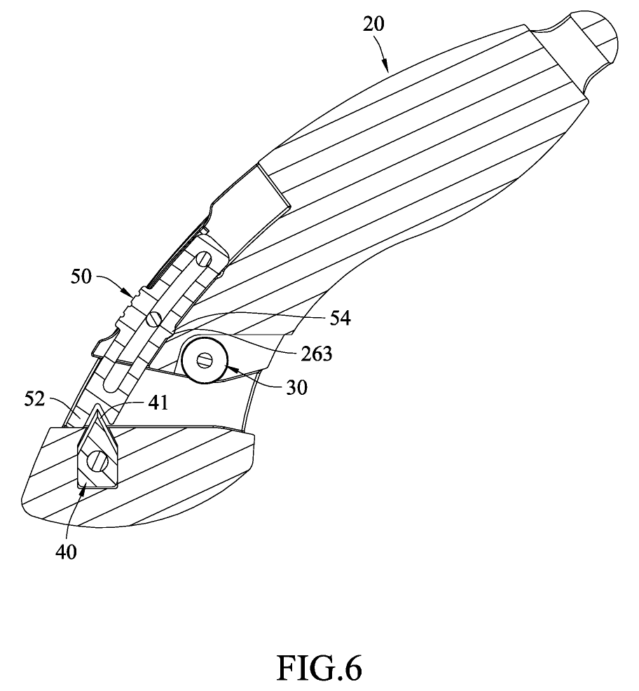

The security component 50 is operably disposed on the body 20 and switched between a first position (shown in FIG. 4) and a second position (shown in FIG. 6). In this embodiment, the security component 50 is operably disposed on the operating groove 26 of the body 20 because of the passage of two rod members 93 through an oblong hole 51 of the security component 50. The security component 50 further has an enclosing portion 52 for enclosing the cutting edge portion 41, a push portion 53 exposed from the body 20 and configured to be pressed and pushed, and a positioning bump 54 configured to be positioned inside the first positioning recess 262 or second positioning recess 263. When the security component 50 is at the first position (shown in FIG. 4), the enclosing portion 52 is neither protruded nor exposed inside the wire duct 23, and the positioning bump 54 is positioned inside the first positioning recess 262. When the security component 50 is at the second position (shown in FIG. 6), the enclosing portion 52 is protruded from the upper duct surface 232 and thus located inside the wire duct 23, enclosing the cutting edge portion 41 of the blade 40.

The arrangement of the main components of the first embodiment of the disclosure is described above. The operation and benefits of the disclosure are described below.

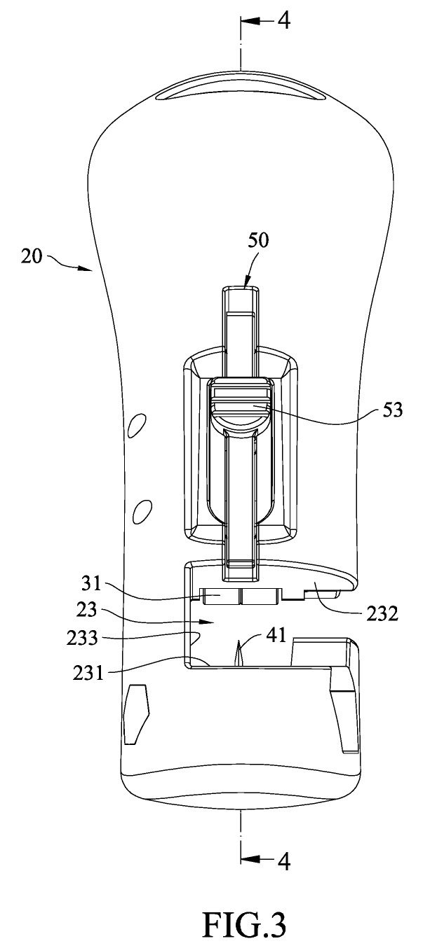

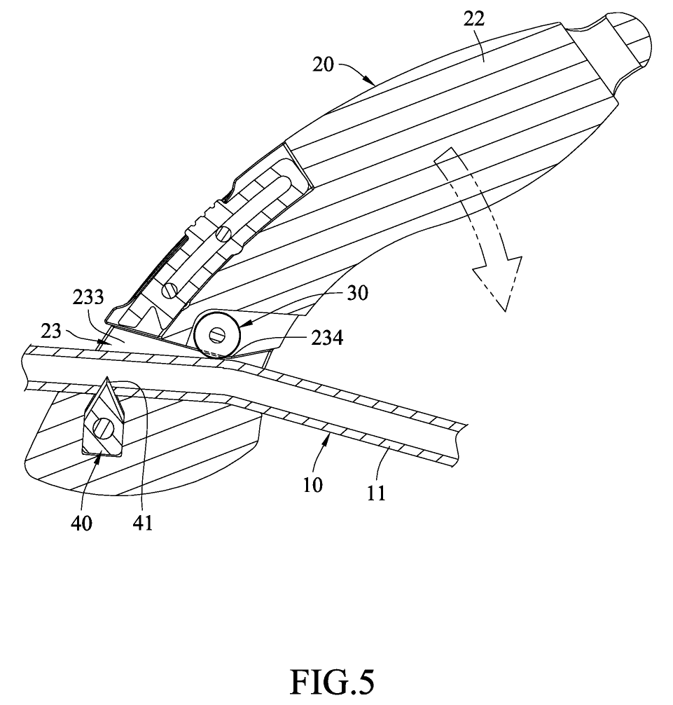

Referring to FIG. 3 through FIG. 5, the longitudinal cutting process performed on the wire 10 involves making good use of the design of the fulcrum portion 234 of the body 20 and the blade 40 to place the wire 10 transversely inside the wire duct 23 of the body 20 such that the upper end of one side of the wire 10 comes into contact with the fulcrum portion 234 (i.e., the roller 30). Then, the gripped body 20 presses against the wire 10 through the roller 30 functioning as a fulcrum to tilt upward to allow the roller 30 to press against one side of the wire 10 and press down the wire 10 according to the lever principle; thus, the cutting edge portion 41 of the blade 40 pierces the lower end of the other side of the wire 10 and penetrates the insulating sheath 11 of the wire 10 to fix the wire 10 in place between the stop portion 24 and the lateral duct surface 233, restraining its lateral displacement.

Then, the upward tilt angle of the body 20 is maintained, the user fixes the wire 10 (or does not need to fix the wire 10 in place on the condition of a sufficient weight of the wire 10) in place with one hand and grips the gripping portion 22 of the body 20 with the other hand to move the wire 10 forward or backward in the lengthwise direction of the wire 10 and thereby finish the longitudinal cutting process of the wire 10, but the disclosure is not limited thereto. In a variant embodiment, the user grips and fixes the body 20 in place with one hand and grips the wire 10 with the other hand to move the wire 10 forward or backward in the lengthwise direction of the wire 10 and thereby finish the longitudinal cutting process of the wire 10.

According to the disclosure, during a wire stripping process, the wire 10 has one end abutting against the fulcrum portion 234 (i.e., the roller 30) and the other end pierced by the cutting edge portion 41 of a fixed height. Thus, the cut made to the wire 10 with the blade 40 has a fixed depth, and thus the conducting wire inside the wire 10 is unlikely to get damaged under an uneven applied force. The longitudinal cutting process performed on the wire 10 is confined to the wire duct 23 of the body 20 to greatly enhance operation safety and reduce hazards that might otherwise occur in the course of the operation. The disclosure not only enhances wire stripping efficiency but also ensures the precision and safety of the operation.

According to the disclosure, the height of the cutting edge portion 41 of the blade 40 is equal to or less than that of the stop portion 24 of the body 20 such that the wire 10 transversely placed inside the wire duct 23 of the body 20 is unlikely to be stopped by the cutting edge portion 41 but can be smoothly inserted into the wire duct 23 and positioned under the roller 30 but over the cutting edge portion 41 of the blade 40, facilitating the longitudinal cutting process to be performed on the wire 10.

Referring to FIG. 4 and FIG. 6, the security component 50 has an enclosing portion 52 corresponding in shape to the cutting edge portion 41 of the blade 40. Thus, when the wire stripper is not in use, the security component 50 is pushed toward the blade 40 to reach the second position, and the positioning bump 54 of the security component 50 is positioned above the second positioning recess 263 of the body 20; meanwhile the enclosing portion 52 of the security component 50 encloses the cutting edge portion 41 of the blade 40, ensuring the user safety while the wire stripper is not in use.

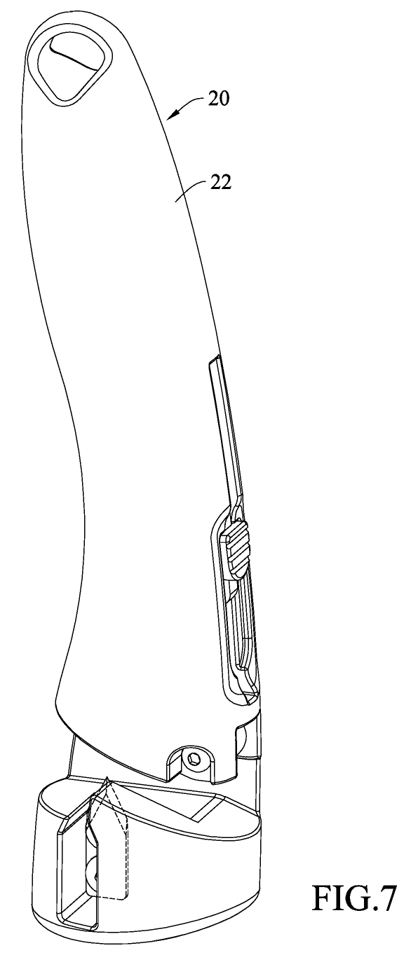

Referring to FIG. 7, a wire stripper is provided in the second embodiment of the disclosure. The technical features that distinguish the second embodiment from the first embodiment are described below.

The bending direction of the gripping portion 22 of the body 20 of the second embodiment is different from that of the first embodiment such that the wire stripper can better adapt to different users’ gripping habits and hand shapes to not only provide smoother and more intuitive user experience but also enhance the users’ operation efficiency and reduce the users’ fatigue.

What is claimed is:

1. A wire stripper, comprising:
a body having a wire duct, the wire duct having a lower duct surface, an upper duct surface facing the lower duct surface, a lateral duct surface connecting the upper duct surface and the lower duct surface, a stop portion disposed on the lower duct surface and spaced apart from the lateral duct surface by a distance, and a fulcrum portion disposed on the upper duct surface and facing the lower duct surface; and
a blade fixedly disposed on the body and having a cutting edge portion protruding from the lower duct surface and thus located inside the wire duct.

2. The wire stripper of claim 1, wherein the fulcrum portion of the body is a roller rotatably disposed on the body and having a roller surface, and a portion of the roller surface protrudes from the upper duct surface and thus is located inside the wire duct.

3. The wire stripper of claim 1, wherein a height of the cutting edge portion of the blade is equal to or less than that of the stop portion of the body.

4. The wire stripper of claim 1, wherein the cutting edge portion of the blade and the fulcrum portion of the body are not aligned with each other.

5. The wire stripper of claim 1, wherein the body further has a receiving portion and a gripping portion connected to the receiving portion, and the wire duct is disposed on the receiving portion.

6. The wire stripper of claim 1, wherein the wire stripper further comprises a security component operably disposed on the body, configured to switch between a first position and a second position, and having an enclosing portion for enclosing the cutting edge portion, allowing the enclosing portion not to be protruded and exposed inside the wire duct when the security component is at the first position, and allowing the enclosing portion to protrude from the upper duct surface and enclose the cutting edge portion when the security component is at the second position.

7. The wire stripper of claim 6, wherein the security component further has a push portion exposed from the body.

8. The wire stripper of claim 6, wherein the body further has an operating groove adjoining the wire duct and having a groove bottom surface, with the groove bottom surface having a first positioning recess and a second positioning recess closer to the wire duct than the first positioning recess, allowing the security component to be operably disposed in the operating groove and have a positioning bump configured to be positioned inside the first positioning recess or the second positioning recess.
